(19) United States
(12) Patent Application Publication
(10) Pub. No.: US 2021/0268852 A1
(43) Pub. Date: Sep. 2, 2021

(54) System for Determining a Support Load That Rests on a Towing Hitch

(71) Applicants: HELLA GmbH & Co. KGaA, Lippstadt (DE); Brink Towing Systems B.V., CX Staphorst (NL)

(72) Inventors: Jan SCHMÄLING, Bad Brückenau (DE); Erwin BOELEN, KD Assen (NL); Ruud HARTVELD, EV Groningen (NL)

(21) Appl. No.: 17/325,927

(22) Filed: May 20, 2021

Related U.S. Application Data
(63) Continuation of application No. PCT/EP2018/082253, filed on Nov. 22, 2018.

(51) Int. Cl. B60D 1/24; B60D 1/04

(52) U.S. Cl. CPC B60D 1/248; B60D 1/46; B60D 1/246; B60D 1/04

(57) ABSTRACT

A system for determining a support load that rests on a towing hitch having a motor for moving a hook of the towing hitch includes: a first electronic device mountable in or on the towing hitch, and a second electronic device mountable in a towing vehicle and connectable to a network of the towing vehicle. The first electronic device includes an input for receiving an electrical value of the motor from a motor sensor that measures the electrical value of the motor, and a unit for determining the support load as a function of the measured electrical value. The first and second electronic devices have an interface for a communication therebetween.

### CROSS REFERENCE TO RELATED APPLICATIONS

This application is a continuation of International Application No. PCT/EP2018/082253, filed on Nov. 22, 2018, the entire contents of which are hereby incorporated by reference.

### TECHNICAL FIELD

Described is a system for determining a support load that rests on a towing hitch with a motor for moving a hook of the towing hitch, having a first electronic device mountable in or on the towing hitch, and having a second electronic device mountable in a towing vehicle and connectable to a network of the towing vehicle. The system has an input for a motor sensor, in particular a motor current sensor to which a motor sensor of the motor, in particular a motor current sensor can be connected, with which at least one electrical value of the motor, in particular a motor current can be measured.

### BACKGROUND

Document EP 2 724 876 A1 discloses a towing hitch. The document discloses an electrically operated towing hitch that can be moved out of sight behind the bumper when not in use. The disclosed towing hitch has a first motor with which the hook of the towing hitch can be moved from a position in which the towing hitch is not in use to a position in which it is in use. The disclosed towing hitch has a second motor which can be used to lock the hook when the hook is moved in the position for use. The first and second motors are controlled by a control unit of the towing hitch. The document also indicates that a sensor is provided to detect a current from the second motor in order to determine the support load on the towing hitch.

Furthermore a second electronic device is known as so-called Trailer Towing Module (TTM) distributed for use in towing vehicles. A measurement signal such as that of the sensor for the current of the second motor in the document EP 2 724 876 A1 can be transmitted to the second electronic device of the towing vehicle via an interface of the coupling and an input of the second electronic devices. The second electronic devices is set up to determine the support load from the measurement signal. The second electronic devices can generate a signal indicating the support load and make it available at an interface, preferably a bus interface, for further use in the vehicle for example for displaying it to a driver or for warning the driver if the support load is too high.

This method of determining the support load has several disadvantages. The transmission of the measurement signal from the sensor to the second electronic devices takes place via long circuits. These circuits can be exposed to the weather or mechanical loads. Both can affect the measurement signal on its way from the sensor to the second electronic devices. Among other things, it may be necessary to provide for large error tolerances.

Further, the sensor signal provides a measured value of an electrical value that occurs in the motor of the hitch. A value for the support load can be determined from this value only if various parameters of the trailer coupling are known, which can differ from trailer hitch type to trailer hitch type and even for different trailer hitches of one type. In order for the second electronic devices to be able to determine the support load, these parameters must be made known to the second electronic devices, which can only be done once it has been determined which trailer hitch is to be mounted on the towing vehicle. As a result, the second electronic devices must be parameterized when the trailer coupling is fitted, which can be cumbersome and error-prone. This is where the present invention can help.

### SUMMARY

The described system addresses the problem of improving a system that can be used with a towing hitch of the type mentioned above such that the measurements are less sensitive to errors and that time-consuming parameterization of the second electronic devices can be omitted.

According to the described system, this task is solved by a system comprising a first electronic device comprising an input for a motor sensor and a unit for determining the support load as a function of the at least one measured electrical value, wherein the first electronic device and the second electronic device each have an interface for a communication between each other.

In contrast to the towing hitch known from document EP 2 724 876 A1, the measuring signal of the sensor is not transmitted to the second electronic device. Instead, the unit used to determine the support load, which is provided in the first electronic device of the system according to the invention, determines the support load from the measurement signal. Individual parameters of the towing hitch that are stored in the unit for determining the support load can be included in the determination. The unit for determining the support load can be provided in the close vicinity of the sensor, so that long transmission paths from the sensor to the unit for determining the support load can be omitted. This not only reduces the cabling effort, but also reduces tolerances, as the shorter transmission path is less prone to errors and malfunctions. The unit for determining the support load may be a hardware unit or a software unit.

In one embodiment, the unit for determining the support load can be a microcontroller or it can include a microcontroller. The microcontroller could be part of an electronic control unit (ECU), which can be used for the control of one or more motors of the towing hitch. The first electronic device can be such an electronic control unit (ECU). Nevertheless, the control of the at least one motor could be implemented in the second electronic device alternatively.

The connection for a communication between the first electronic device and the second electronic device can be a Local Interconnect Network Bus (LIN-Bus) or any other kind of bus. Therefore, the communication interfaces of the first and second device can be LIN-Bus-interfaces. According to other options, the interface can be a Bluetooth interface, a ZigBee interface, or a WIFI interface.

It has been found that the electrical value, in particular the motor current used to determine the support load, not only depends on the support load exerted on the towing hitch, but also on the temperature in the area of the towing hitch. It is therefore particularly advantageous to include the temperature in the determination of the support load. It can therefore be assumed that the first electronic device has at least one input for at least one sensor for measuring the temperature in the region of the hook. It is advantageous that the unit for determining the support load is connected or connectable to the sensor for measuring the temperature. Then it is possible that the unit for determining the support load determines the support load as a function of the measured temperature.

Further sensors can be connectable to the first electronic device. These can supply measured values which are used to determine the support load. However, sensors may be provided for determining measured values which are not relevant for determining the support load. These values can possibly be transferred to the second electronic device or another component in the towing vehicle. Thus, a sensor for measuring a trailer angle may be provided.

### BRIEF DESCRIPTION OF THE DRAWINGS

The disclosed system is explained in more detail below on the basis of the attached drawing.

FIG. 1 is a block diagram of a system comprising a first electronic device and a second electronic device, arranged in a towing vehicle.

### DETAILED DESCRIPTION

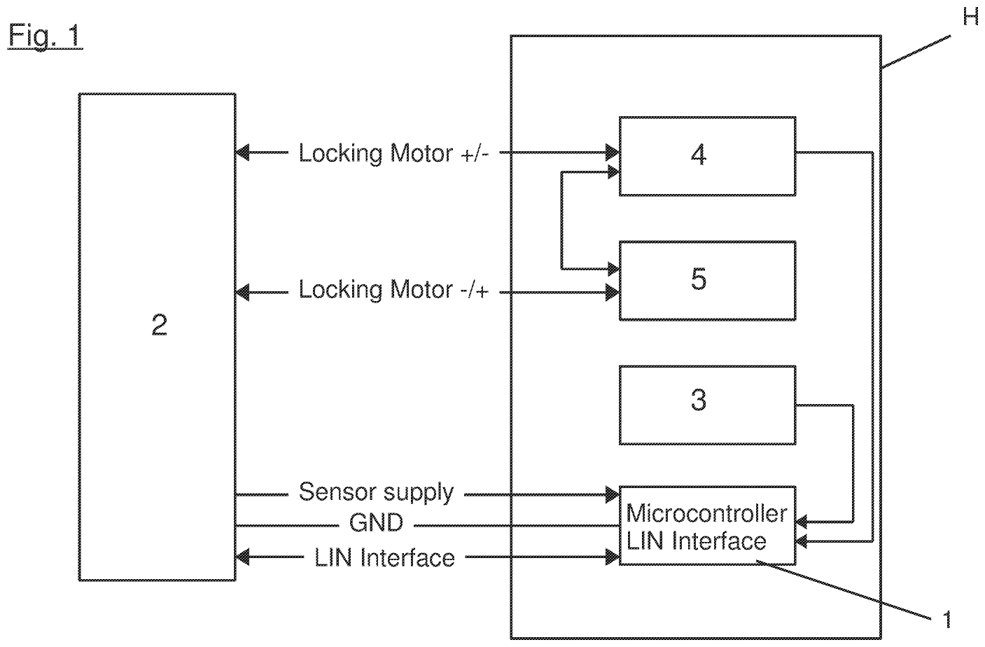

In the block diagram of FIG. 1, reference symbol 1 denotes the first electronic device according to the disclosed system. The first electronic device 1 may be a part of a towing hitch H and may be mounted in or on a hook of the towing hitch.

The towing hitch H is connected to the second electronic device 2 via various lines, including a communication line, e.g., a LIN bus line that connects the first electronic device 1, which includes a LIN bus interface, to the second electronic device 2. Supply lines are also provided to supply sensors 3, 4, a motor 5 and the first electronic device 1.

The system shown in FIG. 1 comprises a sensor 4 for measuring an electrical value, such as, e.g., a current sensor, with which an electrical value, such as the current of the motor 5 of the towing hitch can be measured. The towing hitch H may further comprise a temperature sensor 3, for measuring the temperature in the area of the towing hook. The sensors 3, 4 are connected to the first electronic device 1.

The motor 5 of the towing hitch H is used to exert a force on a hook of the towing hitch H. If a trailer is supported on the towing hitch H, the motor 5 works against the support load. The greater the support load, the more power the motor 5 needs to work against the support load. The greater the power required to work against the support load, the greater the motor current detected by the current sensor 4.

The motor 5 may only be intended to enable the support load to be determined. Preferably, however, the motor 5 also has other functions. For example, the towing hitch H can be a towing hitch like that known from document EP 2 724 876 A1 and can be moved out of sight behind the bumper when not in use.

The first electronic device 1 is programmed such that it can determine the support load from measured values for temperature and motor current supplied by sensors 3, 4. This can be done, for example, by calculation, by looking up a look-up table or by other methods.

The determined support load is then transmitted to the second electronic device 2 via the interface of the first electronic device 1 and can then be used in the towing vehicle. The second electronic device 2 is mounted in the towing vehicle and is connected to a network of the towing vehicle. Via this network, the second electronic device 2 can distribute a signal indicating a value of the support load.

What is claimed is:

1. A system for determining a support load that rests on a towing hitch with a motor for moving a hook of the towing hitch, the system comprising:
a first electronic device mountable in or on the towing hitch and comprising: an input for receiving, from a motor sensor, at least one electrical value of the motor measured by the motor sensor; and a unit to determine the support load as a function of the at least one electrical value;
a second electronic device mountable in a towing vehicle and connectable to a network of the towing vehicle; and
an interface to enable communication between the first and second electronic devices.

2. The system of claim 1, wherein at least one of the first and second electronic devices is or comprises a microcontroller.

3. The system of claim 1, wherein the interface is one of: a Local Interconnect Network Bus (LIN-Bus) interface, a Bluetooth interface, a ZigBee interface, and a WIFI interface.

4. The system of claim 1, wherein the first electronic device includes at least one input from a temperature sensor for measuring a temperature in a region of the hook.

5. The system of claim 4, wherein the unit to determine the support load is connected to the input from the temperature sensor and/or the motor sensor.

6. The system of claim 5, wherein the at least one electrical value of the motor is indicative of a motor current.

7. The system of claim 5, wherein the unit to determine the support load is configured to determine the support load as a function of the measured temperature.

8. The system of claim 1, wherein the first electronic device includes at least one input for a sensor for measuring a trailer angle.

9. The system of claim 1, wherein the second electronic device comprises a trigger unit to trigger the first electronic device to determine the support load.

10. The system of claim 1, wherein the second electronic device is connected to a human machine interface and/or another component of the towing vehicle.

11. The system of claim 10, wherein the second electronic device and/or the human machine interface and/or the other component are configured to indicate the support load in the event the determined support load is outside a prescribed range.
